(19) United States
(12) Patent Application Publication
(10) Pub. No.: US 2026/0339684 A1
(43) Pub. Date: Oct. 29, 2026

(54) PAGE DISPLAY METHOD AND APPARATUS, DEVICE, AND STORAGE MEDIUM

(71) Applicant: Beijing Youzhuju Network Technology Co., Ltd., Beijing (CN)

(72) Inventor: Xi ZHANG, Beijing (CN)

(21) Appl. No.: 19/483,595

(22) PCT Filed: May 24, 2024
(86) PCT No.: PCT/CN2024/095042

§ 371 Date: Nov. 11, 2025

(30) Foreign Application Priority Data
Jun. 26, 2023 (CN) 202310764336.4

(51) Int. Cl. G06F 9/451

(52) U.S. Cl. CPC G06F 9/451

(57) ABSTRACT

The present disclosure provides a method for page displaying, an electronic device and a storage medium. And the method includes: displaying, on a preset page, a set of preset resources distributed to a user, wherein the set of preset resources includes a preset special resource corresponding to at least one preset theme in a target function; and entering a target page of the target function in response to a trigger operation of the user for a first preset special resource, and displaying, on top of the target page, a first theme page corresponding to the first preset special resource, where a current display size of the first theme page is less than a preset display size of the target page, and the first preset special resource is configured for the user to complete a preset interaction event on the first theme page.

The present application claims priority to Chinese Patent Application No. 202310764336.4, filed on Jun. 26, 2023, which is incorporated herein by reference in its entirety as a part of the present application.

### TECHNICAL FIELD

Embodiments of the present disclosure provide a method for page displaying and apparatus, a device, and a storage medium.

### BACKGROUND

With the rapid development of information technologies and the popularization of the mobile Internet, applications have increasingly diversified functions. In some functions, resources can be distributed to users, and the users can use acquired resources to complete corresponding interaction events in the functions. An online shopping function is used as an example. Resources such as coupons can be distributed to users, and the users can use acquired coupons to purchase commodities in the online shopping function.

### SUMMARY

Embodiments of the present disclosure provide a method for page displaying and apparatus, a storage medium, and a device, which can optimize a page display solution.

An embodiment of the present disclosure provides a method for page displaying, including: displaying, on a preset page, a set of preset resources distributed to a user, where the set of preset resources includes a preset special resource corresponding to at least one preset theme in a target function; and entering a target page of the target function in response to a trigger operation of the user for a first preset special resource, and displaying, on top of the target page, a first theme page corresponding to the first preset special resource, where a current display size of the first theme page is less than a preset display size of the target page, and the first preset special resource is configured for the user to complete a preset interaction event on the first theme page.

An embodiment of the present disclosure further provides a page display apparatus, including: a resource set display module configured to display, on a preset page, a set of preset resources distributed to a user, where the set of preset resources includes a preset special resource corresponding to at least one preset theme in a target function; and a page display module configured to enter a target page of the target function in response to a trigger operation of the user for a first preset special resource, and display, on top of the target page, a first theme page corresponding to the first preset special resource, where a current display size of the first theme page is less than a preset display size of the target page, and the first preset special resource is configured for the user to complete a preset interaction event on the first theme page.

An embodiment of the present disclosure further provides an electronic device. The electronic device includes:
one or more processors; and
a storage apparatus configured to store one or more programs, where
the one or more programs, when executed by the one or more processors, cause the one or more processors to implement the method for page displaying provided in the embodiments of the present disclosure.

An embodiment of the present disclosure further provides a storage medium including computer-executable instructions, where the computer-executable instructions, when executed by a computer processor, are configured to perform the method for page displaying provided in the embodiments of the present disclosure.

### BRIEF DESCRIPTION OF DRAWINGS

The above-mentioned and other features, advantages, and aspects of embodiments of the present disclosure become more apparent with reference to the following specific implementations and accompanying drawings. Throughout the accompanying drawings, the same or similar reference numerals denote the same or similar elements. It should be understood that the accompanying drawings are schematic and that parts and elements are not necessarily drawn to scale.

FIG. 1 is a schematic flowchart of a method for page displaying according to an embodiment of the present disclosure;

FIG. 2 is a schematic diagram of an interface interaction according to an embodiment of the present disclosure;

FIG. 3 is a schematic diagram of another interface interaction according to an embodiment of the present disclosure;

FIG. 4 is a schematic flowchart of a method for page displaying according to an embodiment of the present disclosure;

FIG. 5 is a schematic diagram of still another interface interaction according to an embodiment of the present disclosure;

FIG. 6 is a schematic structural diagram of a page display apparatus according to an embodiment of the present disclosure; and

FIG. 7 is a schematic structural diagram of an electronic device according to an embodiment of the disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include” and variants thereof used herein indicate open inclusion, that is, “include but are not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an alternative but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above-mentioned process of notifying and obtaining the authorization of the user is only illustrative and does not constitute a limitation on the implementations of the present disclosure, and other manners that satisfy the relevant laws and regulations may also be applied in the implementations of the present disclosure.

It can be understood that the data involved in the technical solutions (including, but not limited to, the data itself and the enter to or use of the data) shall comply with the requirements of corresponding laws, regulations, and relevant provisions.

FIG. 1 is a schematic flowchart of a method for page displaying according to an embodiment of the present disclosure. This embodiment of the present disclosure is applicable to a case of page display. The method may be performed by a page display apparatus. The apparatus may be implemented in the form of software and/or hardware, and optionally, by an electronic device. The electronic device may be a mobile terminal such as a mobile phone, a smart watch, a tablet computer, or a personal digital assistant, or may be a device such as a personal computer (PC) or a server.

As shown in FIG. 1, the method includes the following steps.

Step 101: Display, on a preset page, a set of preset resources distributed to a user, where the set of preset resources includes a preset special resource corresponding to at least one preset theme in a target function.

In this embodiment of the present disclosure, the preset page may be a page in a preset application. The preset application may provide one or more functions, and may be installed in an electronic device. A specific type of the preset application is not limited. For example, the preset application may be a video application, a live streaming application, a shopping application, an information application, or a game application, or may be another type of application, for example, an application with combined functions of videos and shopping, namely an application providing a plurality of functions.

For example, the target function may be a function that is provided by the preset application for the user, such as an online shopping function or a video play function. The user may complete, in the target function, a preset interaction event, such as purchasing a commodity, viewing videos, or live streaming. A server corresponding to the preset application may distribute a preset resource, such as a coupon or a viewing time voucher, to the user for use during a process of completing the preset interaction event. Optionally, the preset page may be a completion page of the preset interaction event.

For example, in the target function, a plurality of themes may be preset, to facilitate the user in completing the preset interaction event in different themes. A shopping scenario is used as an example. The preset themes may include a preset shopping theme that may be specifically different types of shopping activities, such as seckill activities or promotions. A video play scenario is used as an example. The preset themes may include a preset video theme that may be specifically play of different types of videos, such as series, a variety show, or a sports event.

For example, the preset resources distributed to the user by the server corresponding to the preset application may include a preset general resource for the target function, which may be, for example, a coupon supported by all commodities in the online shopping function or a viewing time voucher supported by all videos in a video library. The preset resources may further include a preset special resource corresponding to the preset theme, which may be, for example, a coupon supported in a preset shopping theme or a viewing time voucher supported by a video type. The set of preset resources displayed on the preset page includes a preset special resource corresponding to at least one preset theme, and each preset theme corresponds to at least one preset special resource. A manner in which resources in the set of preset resources are displayed is not limited. For example, the resources may be displayed in the form of a horizontal list, a longitudinal list, or a matrix. When the set of preset resources is displayed, attribute information of a preset resource may be displayed, such as a resource category (a preset general resource or a preset special resource), a name, resource content (for example, a coupon amount), a usage condition (for example, a validity period), and acquisition state information (for example, acquired or to-be-acquired).

Step 102: Enter a target page of the target function in response to a trigger operation of the user for a first preset special resource, and display, on top of the target page, a first theme page corresponding to the first preset special resource, where a current display size of the first theme page is less than a preset display size of the target page, and the first preset special resource is configured for the user to complete a preset interaction event on the first theme page.

For example, the first preset special resource is included in the set of preset resources, may be any preset special resource in the set of preset resources, and may be understood as a preset special resource currently selected by the user. The trigger operation for the first preset special resource may be, for example, an operation such as tapping, and may be specifically a trigger operation for a preset control associated with the first preset special resource. The preset control may be, for example, a “To apply” control or a “To acquire” control.

For example, there may be a plurality of pages for the target function, including the target page and a theme page corresponding to each preset theme. The target page may be any page for the target function, which is not specifically limited. Optionally, the target page may include a page entry to at least one theme page, and the user may use the preset general resource to complete the preset interaction event through the target page. On the theme page, the user may use a preset special resource corresponding to the theme page to complete the preset interaction event. After the user triggers the first preset special resource, the preset page jumps to the target page of the target function, and at the same time, the first theme page corresponding to the first preset special resource is displayed on top of the target page. The current display size of the first theme page is less than the preset display size of the target page, for example, the current display size of the first theme page is a preset proportion of the preset display size, where the preset proportion is less than 1, for example, 70%. In this way, some content in the target page and the first theme page can be displayed to the user simultaneously, thereby facilitating the user in simultaneous viewing. Optionally, the preset display size is a full-screen display size. Optionally, a bottom boundary of the first theme page coincides with a bottom boundary of the target page.

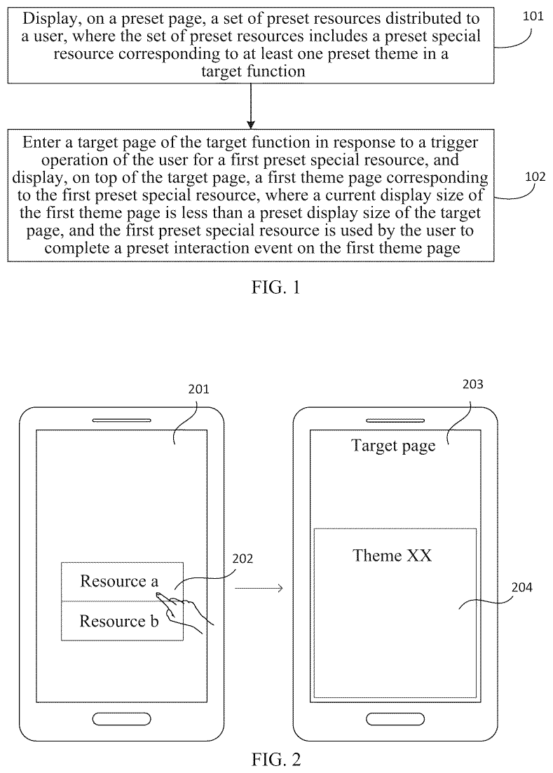

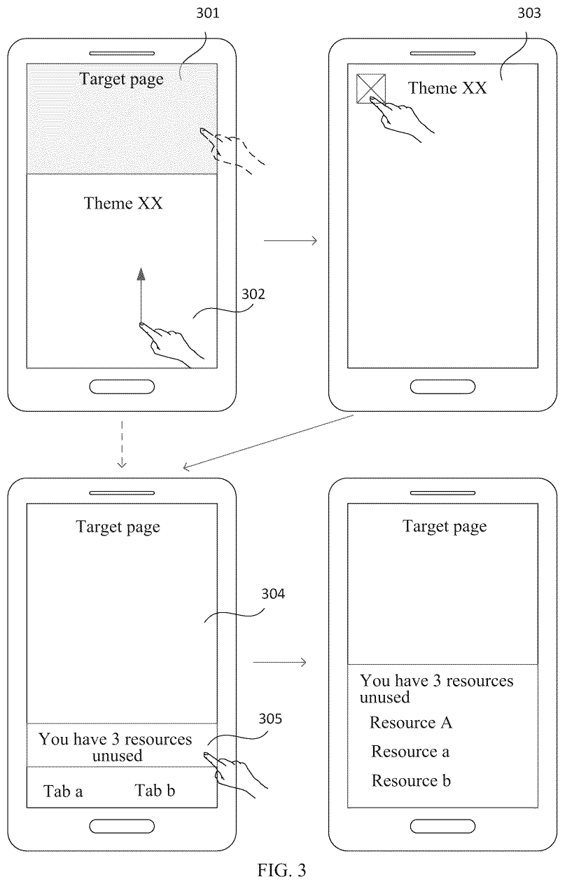

FIG. 2 is a schematic diagram of an interface interaction according to an embodiment of the present disclosure. As shown in FIG. 2, a set of preset resources distributed to a user is displayed on a preset page 201, where the set of preset resources includes preset special resources 202 (for example, a resource a and a resource b in the figure) respectively corresponding to two preset themes. After the user inputs a trigger operation such as tapping for a first preset special resource (for example, the resource a in the figure), a target page 203 is entered, and a theme page 204 corresponding to the resource a is displayed on top of the target page 203, where a current display size of the theme page 204 is less than the target page 203. It can be learned that the user may view the target page 203 and the theme page 204 simultaneously, thereby helping the user quickly select the page the user wants to browse from the target page and the theme page.

According to a method for page displaying provided in an embodiment of the present disclosure, a set of preset resources distributed to a user is displayed on a preset page, where the set of preset resources includes a preset special resource corresponding to at least one preset theme in a target function; and a target page of the target function is entered in response to a trigger operation of the user for a first preset special resource, and a first theme page corresponding to the first preset special resource is displayed on top of the target page, where a current display size of the first theme page is less than a preset display size of the target page, and the first preset special resource is configured for the user to complete a preset interaction event on the first theme page. According to the above-mentioned technical solution, after general resources and special resources distributed to a user are displayed, if the user selects a special resource, a target page and a theme page on which the special resource may be used may be displayed simultaneously, so that the user can conveniently view two pages simultaneously. This helps improve selection efficiency of a page and operation convenience.

In some embodiments, the set of preset resources further includes a preset general resource for the target function. The preset general resource is configured for the user to complete a preset interaction event on the target page. The target page includes a page entry to at least one theme page. In this way, the target page for which the general resource may be used and the theme page for which the special resource may be used can be displayed simultaneously, so that the user can conveniently view two resource use pages simultaneously. This helps improve selection efficiency of a resource use page and operation convenience, and in turn improves resource use efficiency and resource utilization.

In some embodiments, after the displaying, on top of the target page, a first theme page corresponding to the first preset special resource, the method further includes: canceling display of the first theme page on top of the target page in response to a preset operation input by the user for the target page. In this way, the user can conveniently close, by inputting a preset operation for the target page, a theme page that is displayed on top of the target page in an overlay manner, and then browse more information on the target page, so as to use the preset general resource to complete the preset interaction event.

For example, the preset operation may be, for example, a tap operation, such as tapping any location or a specified location on the target page. After the preset operation input by the user for the target page is received, it may be considered that the user wants to browse the target page, and the display of the first theme page on top of the target page is canceled.

In some cases, a theme page is displayed in a full screen, and a page return operation needs to be input on the theme page, to return to a preset page. Then, after one or more page jump operations on the preset page, an entry to a target page can be found to enter the target page. The solution in the embodiments of the present disclosure allows for quick switching from the first theme page to the target page, which reduces an operation path, and effectively improves operation efficiency.

Optionally, when there is a theme page displayed on top of the target page, the target page may be in an inactive state. In the inactive state, the target page does not respond to an interaction operation input by the user for the preset interaction event. For example, a control on the target page is in an inactive state, and cannot be triggered. After the display of the first theme page on top of the target page is canceled, the target page is switched to an active state, and the target page may respond to the interaction operation input by the user for the preset interaction event. For example, the control on the target page is switched to an active state, and can be triggered.

In some embodiments, after the displaying, on top of the target page, a first theme page corresponding to the first preset special resource, the method further includes: canceling display of the first theme page on top of the target page in response to a first page close operation input by the user for the first theme page. The first page close operation may be, for example, a trigger operation for a close control on the first theme page, or may be a gesture operation input for the first theme page (which may be denoted as a first preset gesture operation for ease of differentiation), for example, a swipe-down operation (for example, in a case in which a bottom boundary of the first theme page coincides with a bottom boundary of the target page). In this way, the first theme page can be conveniently closed.

Optionally, the user may cancel the display of the first theme page on top of the target page by inputting any one of the preset operation and the first page close operation, which can reduce an operation path, and effectively improve operation efficiency.

In some embodiments, after the displaying, on top of the target page, a first theme page corresponding to the first preset special resource, the method further includes: adjusting the current display size of the first theme page to the preset display size in response to a preset gesture operation input by the user for the first theme page. In this way, the user can conveniently increase a display size of the first theme page by inputting the preset gesture operation for the first theme page, and then browse more information on the first theme page, so as to use the first preset special resource to complete the preset interaction event.

For example, the preset gesture operation (which may be denoted as a second preset gesture operation for ease of differentiation) may be, for example, a swipe-up operation (for example, in a case in which a bottom boundary of the first theme page coincides with a bottom boundary of the target page). Further, it is assumed that a width of the first theme page is the same as a width of the target page. After the preset gesture operation input by the user for the first theme page is received, the first theme page may be controlled to dynamically extend following a swipe direction of the second preset gesture operation, until a top boundary of the first theme page coincides with a top boundary of the target page.

In some embodiments, after the displaying, on top of the target page, a first theme page corresponding to the first preset special resource, specifically after the adjusting the current display size of the first theme page to the preset display size, the method further includes: canceling display of the first theme page on top of the target page in response to a second page close operation input by the user for the first theme page. In this way, when the first theme page is fully overlaid on top of the target page, the user can conveniently close, by inputting the second page close operation for the first theme page, a theme page that is displayed on top of the target page in an overlay manner, and then browse more information on the target page, so as to use the preset general resource to complete the preset interaction event. This can reduce an operation path, and effectively improve operation efficiency.

For example, the second page close operation may be, for example, a trigger operation for a close control on the first theme page.

FIG. 3 is a schematic diagram of another interface interaction according to an embodiment of the present disclosure. As shown in FIG. 3, after a target page 301 of a target function is entered, and a first theme page 302 corresponding to a first preset special resource is displayed on top of the target page 301, if a user taps an area that is on the target page 301 and that is not covered by the first theme page 302, display of the first theme page 302 on top of the target page 301 may be canceled, to obtain a target page 304 that is displayed in a full screen. If the user inputs a swipe-up operation for the first theme page 302, a first theme page 303 that is displayed in a full screen is obtained. A second page close operation, for example, tapping a close control, is input on the first theme page 303 that is displayed in a full screen, to cancel display of the first theme page 303 that is displayed in a full screen on top of the target page 301 and obtain a target page 304 that is displayed in a full screen.

In some embodiments, after the canceling display of the first theme page on top of the target page, the method further includes: displaying first prompt information in a first preset area of the target page, where the first prompt information includes usage information of the set of preset resources. In this way, after the display of the first theme page on top of the target page is canceled, the user can still view, on the target page, the usage information of the set of preset resources.

For example, the usage information may include attribute information, a usage state (used or unused), and the like of a preset resource. Optionally, the usage information of the set of preset resources may include usage statistics information of the set of preset resources, such as the number of preset resources, a total value, a minimum validity period, and the like, or may include usage information corresponding to each preset resource in the set of preset resources. Optionally, if the usage statistics information is displayed, the usage information corresponding to each preset resource may be displayed after the user triggers the first prompt information. Optionally, a distance between the first preset area and a page boundary of the target page is less than or equal to a preset distance value.

In some embodiments, the first preset area includes an adjacent area of a target area on the target page, where the target area is configured to display a tab identifier.

In some embodiments, after the displaying first prompt information in a first preset area of the target page, the method further includes: displaying the set of preset resources on the target page in response to a trigger operation of the user for the first prompt information; and entering a second theme page corresponding to a second preset special resource in response to a trigger operation of the user for the second preset special resource, where the second preset special resource is configured for the user to complete a preset interaction event on the second theme page. In this way, the user can conveniently enter the second theme page after canceling the display of the first theme page on top of the target page. The second preset special resource is included in the set of preset resources.

Preset themes corresponding to the first theme page and the second theme page may be the same or different, which is not specifically limited.

As shown in FIG. 3, after the target page 304 that is displayed in a full screen is entered, first prompt information 305, for example, “You have 3 resources unused”, or other information, for example, “Expire in 10 hours”, is displayed in an adjacent area of a target area (in which two tab identifiers, namely a tab a and a tab b, are displayed) on the page. After the user inputs a trigger operation for the first prompt information 305, the set of preset resources is displayed on the target page. In this case, a specific display manner may be different from a display manner in which the set of preset resources is displayed on the target page in terms of, for example, at least one of a display style, display content, and a display location. The display content may include, for example, an attribute type and/or attribute value of a displayed preset resource. After the user inputs a trigger operation for the second preset special resource, such as a resource b, a theme page corresponding to the resource b may be directly entered. It can be learned that, after a preset special resource is triggered on a preset page and a preset special resource is triggered on a target page, display manners for corresponding theme pages are different.

In some embodiments, when the first preset special resource is in a to-be-obtained state, the entering a target page of the target function in response to a trigger operation of the user for a first preset special resource, and displaying, on top of the target page, a first theme page corresponding to the first preset special resource includes: obtaining the first preset special resource in response to the trigger operation of the user for the first preset special resource, entering the target page of the target function, displaying, on top of the target page, the first theme page corresponding to the first preset special resource, and displaying second prompt information in a second preset area of the first theme page, where the second prompt information includes usage information corresponding to the first preset special resource. In this way, after the user triggers the preset special resource that is in the to-be-obtained state, for example, tapping “To acquire”, instead of jumping to an acquisition page, the preset special resource is automatically acquired, and the target page and the theme page are displayed, which further shortens an operation path and improves operation efficiency. The second preset area may be, for example, a top area of the theme page, which is not specifically limited.

Optionally, the second prompt information may further include the usage information of the set of preset resources, to facilitate the user in fully understanding a state of a resource that the user can use, and help the user quickly determine a resource use page that the user wants to enter.

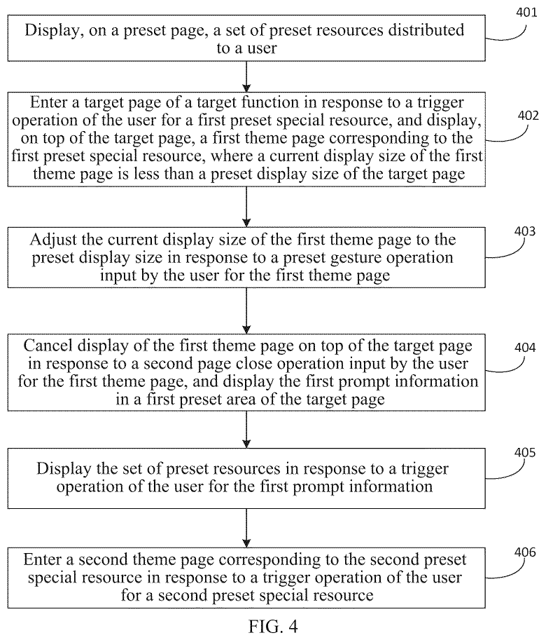

FIG. 4 is a schematic flowchart of a method for page displaying according to an embodiment of the present disclosure. This embodiment of the present disclosure is optimized based on optional solutions in the above-mentioned embodiments. Specifically, the method includes the following steps.

Step 401: Display, on a preset page, a set of preset resources distributed to a user.

The set of preset resources includes a preset general resource for a target function and a preset special resource corresponding to at least one preset theme in the target function.

For example, an online shopping scenario is used as an example. The target function includes an online shopping function, the resources include a coupon, the preset general resource includes a mall coupon, a preset activity includes a shopping activity, the preset special resource includes an activity coupon, and the preset page may be an order completion page, or the like.

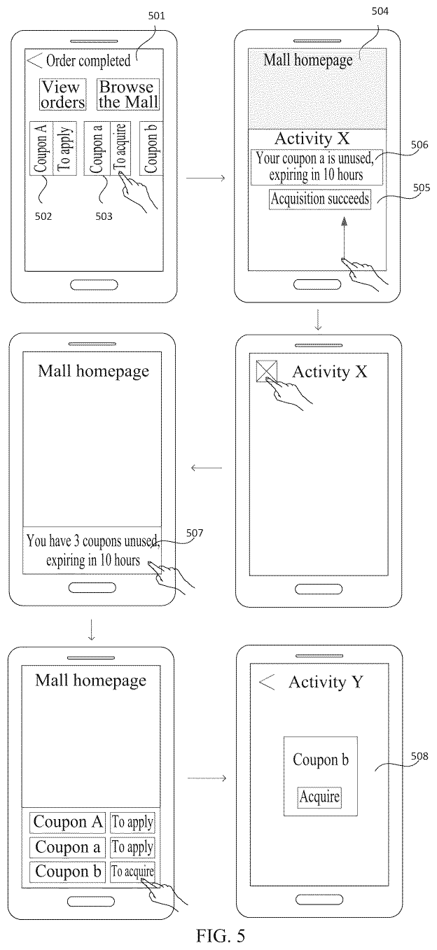

FIG. 5 is a schematic diagram of still another interface interaction according to an embodiment of the present disclosure. As shown in FIG. 5, a set of coupons distributed to the user is displayed on an order completion page 501 as a preset page, where the set of coupons includes a mall coupon 502 and an activity coupon 503. Some coupons in the figure are not fully displayed. More complete or more coupons can be displayed by inputting a gesture operation (for example, swiping to the left).

Step 402: Enter a target page of the target function in response to a trigger operation of the user for a first preset special resource, and display, on top of the target page, a first theme page corresponding to the first preset special resource, where a current display size of the first theme page is less than a preset display size of the target page.

As shown in FIG. 5, the user taps “To acquire” for a coupon a, to enter a mall homepage 504 (the target page), and a first activity page 505 corresponding to the coupon a is displayed on top of the mall homepage 504. In addition, the coupon a is in an unclaimed state on the order completion page 501. Therefore, after tapping “To acquire” for the coupon a, the user can directly acquire the coupon a, and acquire prompt information, for example, “Acquisition succeeds”, is displayed on the first activity page 505. Second prompt information 506 may further be displayed on the first activity page 505, where the second prompt information includes usage information corresponding to the first preset special resource, for example, “Your coupon a is unused, expiring in 10 hours” in the figure. Optionally, the second prompt information may further include usage information of the set of preset resources. For example, the second prompt information has the same content as first prompt information.

Step 403: Adjust the current display size of the first theme page to the preset display size in response to a preset gesture operation input by the user for the first theme page.

As shown in FIG. 5, after the user inputs a swipe-up operation for the first activity page 505, a current display size of the first activity page 505 is adjusted to a preset display size, that is, the first activity page can fully cover the mall homepage.

Step 404: Cancel display of the first theme page on top of the target page in response to a second page close operation input by the user for the first theme page, and display the first prompt information in a first preset area of the target page.

The first prompt information includes the usage information of the set of preset resources.

As shown in FIG. 5, after the user taps a close button on the first activity page with the preset display size, display of the first activity page on top of the mall homepage is canceled, and first prompt information 507, for example, “You have 3 coupons unused, expiring in 10 hours” in the figure, is displayed in a bottom area of the mall homepage.

Step 405: Display the set of preset resources in response to a trigger operation of the user for the first prompt information.

As shown in FIG. 5, after the user taps the first prompt information 507, the set of coupons is displayed on the mall homepage. A display manner for the set of coupons is different from that on the order completion page 501. For example, because the coupon a changes to an acquired state, an associated preset control changes from “To acquire” on the order completion page 501 to “To apply”.

Step 406: Enter a second theme page corresponding to a second preset special resource in response to a trigger operation of the user for the second preset special resource.

As shown in FIG. 5, when triggering “To acquire” corresponding to a coupon b, the user can directly enter a second activity page 508 corresponding to the coupon b.

According to the method for page displaying provided in the embodiments of the present disclosure, after general resources and special resources distributed to a user are displayed, if the user selects a special resource, a target page for which the general resource may be used and a theme page for which the special resource may be used may be displayed simultaneously, so that the user can conveniently view two resource use pages simultaneously, and can conveniently switch to a larger-size display state of the theme page by inputting a gesture operation, facilitating browsing more information on the theme page, so as to use a corresponding preset special resource to complete a preset interaction event. In addition, when there is a need for entering the target page, display of the theme page on top may be quickly canceled by inputting a page close operation, so that a quick return to the target page can be implemented without inputting a plurality of page return and page jump operations, and usage of a set of preset resources can be fully understood on the target page, facilitating the user in using the preset resources more properly. This helps improve selection efficiency of a resource use page and operation convenience, in turn improving resource use efficiency and resource utilization, and improves user's operating experience with a target function, for example, operating experience in an online mall in an online shopping scenario.

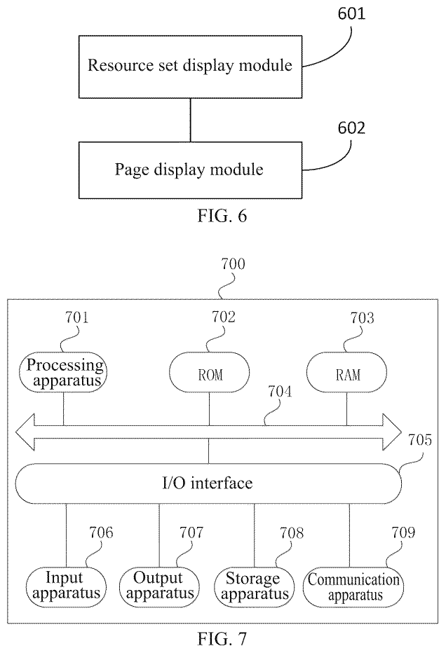

FIG. 6 is a schematic structural diagram of a page display apparatus according to an embodiment of the present disclosure. As shown in FIG. 6, the apparatus includes:
a resource set display module 601 configured to display, on a preset page, a set of preset resources distributed to a user, where the set of preset resources includes a preset special resource corresponding to at least one preset theme in a target function; and
a page display module 602 configured to: enter a target page of the target function in response to a trigger operation of the user for a first preset special resource, and display, on top of the target page, a first theme page corresponding to the first preset special resource, where a current display size of the first theme page is less than a preset display size of the target page, and the first preset special resource is configured for the user to complete a preset interaction event on the first theme page.

According to the page display apparatus provided in the embodiment of the present disclosure, after general resources and special resources distributed to a user are displayed, if the user selects a special resource, a target page and a theme page for which the special resource may be used may be displayed simultaneously, so that the user can conveniently view two pages simultaneously. This helps improve selection efficiency of a page and operation convenience.

Optionally, the set of preset resources further includes a preset general resource for the target function. The preset general resource is configured for the user to complete a preset interaction event on the target page. The target page includes a page entry to at least one theme page.

Optionally, the apparatus further includes:
a size adjustment module configured to adjust the current display size of the first theme page to the preset display size in response to a preset gesture operation input by the user for the first theme page after the first theme page corresponding to the first preset special resource is displayed on top of the target page.

Optionally, the apparatus further includes:
a display cancellation module configured to cancel display of the first theme page on top of the target page in response to a preset operation input by the user for the target page, and/or in response to a page close operation input by the user for the first theme page after the first theme page corresponding to the first preset special resource is displayed on top of the target page.

Optionally, the apparatus further includes:
a first prompt information display module configured to display first prompt information in a first preset area of the target page after the display of the first theme page on top of the target page is canceled, where the first prompt information includes usage information of the set of preset resources.

Optionally, the first preset area includes an adjacent area of a target area on the target page, where the target area is configured to display a tab identifier.

Optionally, the apparatus further includes:
a display module configured to display the set of preset resources on the target page in response to a trigger operation of the user for the first prompt information after the first prompt information is displayed in the first preset area of the target page; and
a page entering module configured to enter a second theme page corresponding to a second preset special resource in response to a trigger operation of the user for the second preset special resource, where the second preset special resource is configured for the user to complete a preset interaction event on the second theme page.

Optionally, the target function includes an online shopping function, the resources include a coupon, the preset theme includes a preset shopping theme, and the preset interaction event includes purchasing a commodity.

The page display apparatus provided in this embodiment of the present disclosure can perform the method for page displaying provided in any embodiment of the present disclosure, and has corresponding functional modules for performing the method and beneficial effects.

It is worth noting that the units and modules included in the above-mentioned apparatus are obtained through division merely according to functional logic, but are not limited to the above-mentioned division, as long as corresponding functions can be implemented. In addition, specific names of the functional units are merely used for mutual distinguishing, and are not used to limit the scope of protection of the embodiments of the present disclosure.

FIG. 7 is a schematic structural diagram of an electronic device according to an embodiment of the present disclosure. Reference is made to FIG. 7 below, which is a schematic structural diagram of an electronic device (such as a terminal device or a server in FIG. 7) 700 suitable for implementing embodiments of the present disclosure. A terminal device in this embodiment of the present disclosure may include, but is not limited to, mobile terminals such as a mobile phone, a notebook computer, a digital broadcast receiver, a personal digital assistant (PDA), a tablet computer (portable Android device, PAD), a portable media player (PMP), and a vehicle-mounted terminal (for example, a vehicle navigation terminal), and fixed terminals such as a digital TV and a desktop computer. The electronic device shown in FIG. 7 is merely an example, and shall not impose any limitation on the function and scope of use of the embodiments of the present disclosure.

As shown in FIG. 7, the electronic device 700 may include a processing apparatus (for example, a central processing unit or a graphics processing unit) 701 that may perform a variety of appropriate actions and processing in accordance with a program stored in a read-only memory (ROM) 702 or a program loaded from a storage apparatus 708 into a random access memory (RAM) 703. The RAM 703 further stores various programs and data required for the operation of the electronic device 700. The processing apparatus 701, the ROM 702, and the RAM 703 are connected to one another through a bus 704. An input/output (I/O) interface 705 is also connected to the bus 704.

Generally, the following apparatuses may be connected to the I/O interface 705: an input apparatus 706 including, for example, a touchscreen, a touchpad, a keyboard, a mouse, a camera, a microphone, an accelerometer, and a gyroscope; an output apparatus 707 including, for example, a liquid crystal display (LCD), a speaker, and a vibrator; the storage apparatus 708 including, for example, a magnetic tape and a hard disk; and a communication apparatus 709. The communication apparatus 709 may allow the electronic device 700 to perform wireless or wired communication with other devices to exchange data. Although FIG. 7 shows the electronic device 700 having various apparatuses, it should be understood that it is not required to implement or have all of the shown apparatuses. It may be an alternative to implement or have more or fewer apparatuses.

According to an embodiment of the present disclosure, the process described above with reference to the flowcharts may be implemented as a computer software program. For example, an embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 709, installed from the storage apparatus 708, or installed from the ROM 702. When the computer program is executed by the processing apparatus 701, the above-mentioned functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The electronic device provided in this embodiment of the present disclosure and the method for page displaying provided in the above-mentioned embodiments belong to the same inventive concept. For the technical details not exhaustively described in this embodiment, reference may be made to the above-mentioned embodiments, and this embodiment and the above-mentioned embodiments have the same beneficial effects.

An embodiment of the present disclosure provides a computer storage medium having a computer program stored thereon. When executed by a processor, the program causes the method for page displaying provided in the above-mentioned embodiments to be implemented.

It should be noted that the above-mentioned computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the HyperText Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above-mentioned computer-readable medium may be contained in the above-mentioned electronic device. Alternatively, the computer-readable medium may exist independently, without being assembled into the electronic device.

The above-mentioned computer-readable medium carries one or more programs that, when executed by the electronic device, cause the electronic device to: display, on a preset page, a set of preset resources distributed to a user, where the set of preset resources includes a preset special resource corresponding to at least one preset theme in a target function; and enter a target page of the target function in response to a trigger operation of the user for a first preset special resource, and display, on top of the target page, a first theme page corresponding to the first preset special resource, where a current display size of the first theme page is less than a preset display size of the target page, and the first preset special resource is configured for the user to complete a preset interaction event on the first theme page.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of a module does not constitute a limitation on the module itself in some cases. For example, the resource set display module may also be described as “a module configured to display, on a preset page, a set of preset resources distributed to a user, where the set of preset resources includes a preset general resource for a target function and a preset special resource corresponding to at least one preset theme in the target function”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, a method for page displaying is provided, including:
displaying, on a preset page, a set of preset resources distributed to a user, where the set of preset resources includes a preset special resource corresponding to at least one preset theme in a target function; and
entering a target page of the target function in response to a trigger operation of the user for a first preset special resource, and displaying, on top of the target page, a first theme page corresponding to the first preset special resource, where a current display size of the first theme page is less than a preset display size of the target page, and the first preset special resource is configured for the user to complete a preset interaction event on the first theme page.

According to one or more embodiments of the present disclosure, the set of preset resources further includes a preset general resource for the target function. The preset general resource is configured for the user to complete a preset interaction event on the target page. The target page includes a page entry to at least one theme page.

According to one or more embodiments of the present disclosure, after the displaying, on top of the target page, a first theme page corresponding to the first preset special resource, the method further includes: adjusting the current display size of the first theme page to the preset display size in response to a preset gesture operation input by the user for the first theme page.

According to one or more embodiments of the present disclosure, after the displaying, on top of the target page, a first theme page corresponding to the first preset special resource, the method further includes: canceling display of the first theme page on top of the target page in response to a preset operation input by the user for the target page, and/or in response to a page close operation input by the user for the first theme page.

According to one or more embodiments of the present disclosure, after the canceling display of the first theme page on top of the target page, the method further includes:
displaying first prompt information in a first preset area of the target page, where the first prompt information includes usage information of the set of preset resources.

According to one or more embodiments of the present disclosure, the first preset area includes an adjacent area of a target area on the target page, where the target area is configured to display a tab identifier.

After the displaying first prompt information in a first preset area of the target page, the method further includes:
displaying the set of preset resources on the target page in response to a trigger operation of the user for the first prompt information; and
entering a second theme page corresponding to a second preset special resource in response to a trigger operation of the user for the second preset special resource, where the second preset special resource is configured for the user to complete a preset interaction event on the second theme page.

According to one or more embodiments of the present disclosure, the target function includes an online shopping function, the resources include a coupon, the preset theme includes a preset shopping theme, and the preset interaction event includes purchasing a commodity.

According to one or more embodiments of the present disclosure, a page display apparatus is provided, including:
a resource set display module configured to display, on a preset page, a set of preset resources distributed to a user, where the set of preset resources includes a preset special resource corresponding to at least one preset theme in a target function; and
a page display module configured to: enter a target page of the target function in response to a trigger operation of the user for a first preset special resource, and display, on top of the target page, a first theme page corresponding to the first preset special resource, where a current display size of the first theme page is less than a preset display size of the target page, and the first preset special resource is configured for the user to complete a preset interaction event on the first theme page.

According to one or more embodiments of the present disclosure, an electronic device is provided, the electronic device including:
one or more processors; and
a storage apparatus configured to store one or more programs, where
the one or more programs, when executed by the one or more processors, cause the one or more processors to implement the method for page displaying provided in the embodiments of the present disclosure.

According to one or more embodiments of the present disclosure, a storage medium including computer-executable instructions is provided, where the computer-executable instructions, when executed by a computer processor, are configured to perform the method for page displaying provided in the embodiments of the present disclosure.

The above-mentioned descriptions are merely preferred embodiments of the present disclosure and explanations of the applied technical principles. Those skilled in the art should understand that the scope of disclosure involved in the present disclosure is not limited to the technical solutions formed by specific combinations of the above-mentioned technical features, and shall also cover other technical solutions formed by any combination of the above-mentioned technical features or equivalent features thereof without departing from the above-mentioned concept of disclosure. For example, a technical solution formed by a replacement of the above-mentioned features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the above-mentioned discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A method for page displaying, comprising:
displaying, on a preset page, a set of preset resources distributed to a user, wherein the set of preset resources comprises a preset special resource corresponding to at least one preset theme in a target function; and
entering a target page of the target function in response to a trigger operation of the user for a first preset special resource, and displaying, on top of the target page, a first theme page corresponding to the first preset special resource, wherein a current display size of the first theme page is less than a preset display size of the target page, and the first preset special resource is configured for the user to complete a preset interaction event on the first theme page.

2. The method according to claim 1, wherein the set of preset resources further comprises a preset general resource for the target function, the preset general resource is configured for the user to complete the preset interaction event on the target page, and the target page comprises a page entry to at least one theme page.

3. The method according to claim 1, wherein after the displaying, on top of the target page, a first theme page corresponding to the first preset special resource, the method further comprises:
adjusting the current display size of the first theme page to the preset display size in response to a preset gesture operation input by the user for the first theme page.

4. The method according to claim 1, wherein after the displaying, on top of the target page, a first theme page corresponding to the first preset special resource, the method further comprises:
canceling display of the first theme page on top of the target page in response to a preset operation input by the user for the target page, and/or in response to a page close operation input by the user for the first theme page.

5. The method according to claim 4, wherein after the canceling display of the first theme page on top of the target page, the method further comprises:
displaying first prompt information in a first preset area of the target page, wherein the first prompt information comprises usage information of the set of preset resources.

6. The method according to claim 5, wherein the first preset area comprises an adjacent area of a target area on the target page, and the target area is configured to display a tab identifier; and
after the displaying first prompt information in a first preset area of the target page, the method further comprises:
displaying the set of preset resources on the target page in response to a trigger operation of the user for the first prompt information; and
entering a second theme page corresponding to a second preset special resource in response to a trigger operation of the user for the second preset special resource, wherein the second preset special resource is configured for the user to complete the preset interaction event on the second theme page.

7. The method according to claim 1, wherein the target function comprises an online shopping function, a resource comprises a coupon, the preset theme comprises a preset shopping theme, and the preset interaction event comprises purchasing a commodity.

8. The method according to claim 4, wherein the preset operation comprises a tap operation.

9. The method according to claim 1, wherein the target page comprises an inactive state and an active state;
in the inactive state, the target page does not respond to an interaction operation input by the user for the preset interaction event; and
in the active state, the target page responds to the interaction operation input by the user for the preset interaction event.

10. The method according to claim 4, wherein the page close operation input for the first theme page comprises:
a trigger operation for a close control on the first theme page, or a gesture operation input for the first theme page.

11. The method according to claim 5, wherein the usage information of the set of preset resources comprises:
usage statistics information of the set of preset resources, or usage information corresponding to each preset resource in the set of preset resources.

12. The method according to claim 1, wherein when the first preset special resource is in a to-be-obtained state, the entering a target page of the target function in response to a trigger operation of the user for a first preset special resource, and displaying, on top of the target page, a first theme page corresponding to the first preset special resource comprises:
obtaining the first preset special resource in response to the trigger operation of the user for the first preset special resource, entering the target page of the target function, displaying, on top of the target page, the first theme page corresponding to the first preset special resource, and displaying second prompt information in a second preset area of the first theme page, wherein the second prompt information comprises usage information corresponding to the first preset special resource.

13. (canceled)

14. An electronic device, comprising:
one or more processors; and
a storage apparatus configured to store one or more programs, wherein
the one or more programs, when executed by the one or more processors, cause the one or more processors to implement a method for page displaying, wherein the method comprises:
displaying, on a preset page, a set of preset resources distributed to a user, wherein the set of preset resources comprises a preset special resource corresponding to at least one preset theme in a target function; and
entering a target page of the target function in response to a trigger operation of the user for a first preset special resource, and displaying, on top of the target page, a first theme page corresponding to the first preset special resource, wherein a current display size of the first theme page is less than a preset display size of the target page, and the first preset special resource is configured for the user to complete a preset interaction event on the first theme page.

15. non-transitory storage medium comprising computer-executable instructions, wherein the computer-executable instructions, when executed by a computer processor, are configured to perform a method for page displaying, wherein the method comprises:
displaying, on a preset page, a set of preset resources distributed to a user, wherein the set of preset resources comprises a preset special resource corresponding to at least one preset theme in a target function; and
entering a target page of the target function in response to a trigger operation of the user for a first preset special resource, and displaying, on top of the target page, a first theme page corresponding to the first preset special resource, wherein a current display size of the first theme page is less than a preset display size of the target page, and the first preset special resource is configured for the user to complete a preset interaction event on the first theme page.

16. The electronic device according to claim 14, wherein the set of preset resources further comprises a preset general resource for the target function, the preset general resource is configured for the user to complete the preset interaction event on the target page, and the target page comprises a page entry to at least one theme page.

17. The electronic device according to claim 14, wherein after the displaying, on top of the target page, a first theme page corresponding to the first preset special resource, the method further comprises:
adjusting the current display size of the first theme page to the preset display size in response to a preset gesture operation input by the user for the first theme page.

18. The electronic device according to claim 14, wherein after the displaying, on top of the target page, a first theme page corresponding to the first preset special resource, the method further comprises:
canceling display of the first theme page on top of the target page in response to a preset operation input by the user for the target page, and/or in response to a page close operation input by the user for the first theme page.

19. The electronic device according to claim 18, wherein after the canceling display of the first theme page on top of the target page, the method further comprises:
displaying first prompt information in a first preset area of the target page, wherein the first prompt information comprises usage information of the set of preset resources.

20. The electronic device according to claim 19, wherein the first preset area comprises an adjacent area of a target area on the target page, and the target area is configured to display a tab identifier; and
after the displaying first prompt information in a first preset area of the target page, the method further comprises:
displaying the set of preset resources on the target page in response to a trigger operation of the user for the first prompt information; and
entering a second theme page corresponding to a second preset special resource in response to a trigger operation of the user for the second preset special resource, wherein the second preset special resource is configured for the user to complete the preset interaction event on the second theme page.

21. The electronic device according to claim 14, wherein the target function comprises an online shopping function, a resource comprises a coupon, the preset theme comprises a preset shopping theme, and the preset interaction event comprises purchasing a commodity.
